(19) United States
(12) Patent Application Publication
(10) Pub. No.: US 2023/0029312 A1
(43) Pub. Date: Jan. 26, 2023

(54) SIMILARITY-BASED SEARCH FOR FRAUD PREVENTION

(71) Applicant: AT&T Intellectual Property I, L.P., Atlanta, GA (US)

(72) Inventors: Prince Paulraj, Coppell, TX (US); Arun Luthra, San Francisco, CA (US); Ana Armenta, San Jose, CA (US); Jean Luo, Millbrae, CA (US)

(21) Appl. No.: 17/382,746

(22) Filed: Jul. 22, 2021

(51) Int. Cl. G06Q 40/02; G06Q 20/40; G06K 9/62

(52) U.S. Cl. CPC G06Q 40/025; G06Q 20/4016; G06Q 20/4014; G06K 9/6276

(57) ABSTRACT

To detect multiple suspicious patterns while at the same time keeping the number of model parameters low, a learned aggregation model is used to distinguish suspiciously similar applications from unrelated applications.

### BACKGROUND

With the trend of smartphones becoming more and more expensive, and the willing-ness by telecoms to lend these to customers with little or no up-front payment, there is an increasing need to accurately assess credit risk across the customer base. Correct identity information allows the business to look up the right credit file for the customer. As a result, many fraud strategies by bad actors are centered around submitting bad or stolen identity information.

There are several example of different fraud strategies, which were discovered during investigation. In a first review of credit applications were searched where the same first name, last name, and DOB is associated with multiple distinct social security numbers (SSNs). In a certain date range, there were over 130,000 groupings of First/Last/DOB associated with 2 different SSNs, 16,000 with 3 different SSNs, and so on. In one case, there were 98 different SSNs associated to a single name/DOB pair.

In a second review of credit applications were searched for the same first name, last name, DOB, and phone number (and filtering for records where the SSN, DOB, and phone are provided). For this example, over 60,000 associated with 2 different SSN, 8000 with 3 SSNs, and so on were found. There was one name/DOB/phone combination associated with 49 different SSNs.

Other suspicious patterns may exist in the data. Inspection of the data reveal various strategies that are indeed being used to make small and large changes to the same underlying identities. This can be described as “identity permutation” fraud.

This background information is provided to reveal information believed by the applicant to be of possible relevance. No admission is necessarily intended, nor should be construed, that any of the preceding information constitutes prior art.

### SUMMARY

Bad actors sometimes submit multiple fraudulent credit applications that include small variations on valid identity information. To detect this type of fraud in real time, we use a search engine based on locality-sensitive hashing to compare new applications with similar applications have been submitted in the past. To detect multiple suspicious patterns while at the same time keeping the number of model parameters low, a learned aggregation model is used to distinguish suspiciously similar applications from unrelated applications. In an example, search results may be scored by a neural network and aggregated with the 3-Π Uninorm function to produce a fraud propensity score for each new credit application.

In an example, an apparatus may include a processor and a memory coupled with the processor that effectuates operations. The operations may include receiving a query associated with a credit application; in response to the query, determining neighbor applications associated with the credit application; ranking the neighbor applications; determining that a first neighbor application of the neighbor applications is ranked within a first threshold; and assigning a similarity score for the first neighbor application and the credit application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for similarity-based search for fraud prevention.

FIG. 2 illustrates an exemplary method for similarity-based search for fraud prevention.

FIG. 3 illustrates a schematic of an exemplary network device.

FIG. 4 illustrates an exemplary communication system that provides wireless telecommunication services over wireless communication networks.

### DETAILED DESCRIPTION

With the trend of smartphones becoming more and more expensive, and the willingness by telecoms to lend these to customers with little or no up-front payment, there is an increasing need to accurately assess credit risk across the customer base. Correct identity information allows the business to look up the right credit file for the customer. As a result, many fraud strategies by bad actors are centered around submitting bad or stolen identity information.

There are multiple strategies by bad actors for committing fraud. In a first example, there may be re-use of the same identity information in different credit applications over time, but with omissions or changes made to certain fields that are considered more optional, such as physical address, contact phone number or email address. In a second example, there may be re-use of the same identity with small changes made to several fields. In a third example, there may be re-use of the same identity with large changes made to several fields, but with no change made to certain fields (such as Last Name, SSN, DOB) that are significant to the credit check.

Comparisons of the new credit application against several months worth of previous applications can be made in real time. This may be implemented with a normal hash table that can look up exact matches to previously submitted identity fields in O(1) “constant time”.

In other cases, suspicious identity re-use may be more difficult to detect if uniquely identifying traits, such as social security number (SSN) or phone number, have been changed by even a small amount. Changing a single digit in a SSN or phone number is enough for an exact match search to return no results. Whether or not bad actors were successful in getting around fraud detection procedures by using this type of strategy, the fact that the fraudster tried this type of data submission may be a useful signal in the future if cross referenced with subsequent applications against the database of previous applications and take note of similarities.

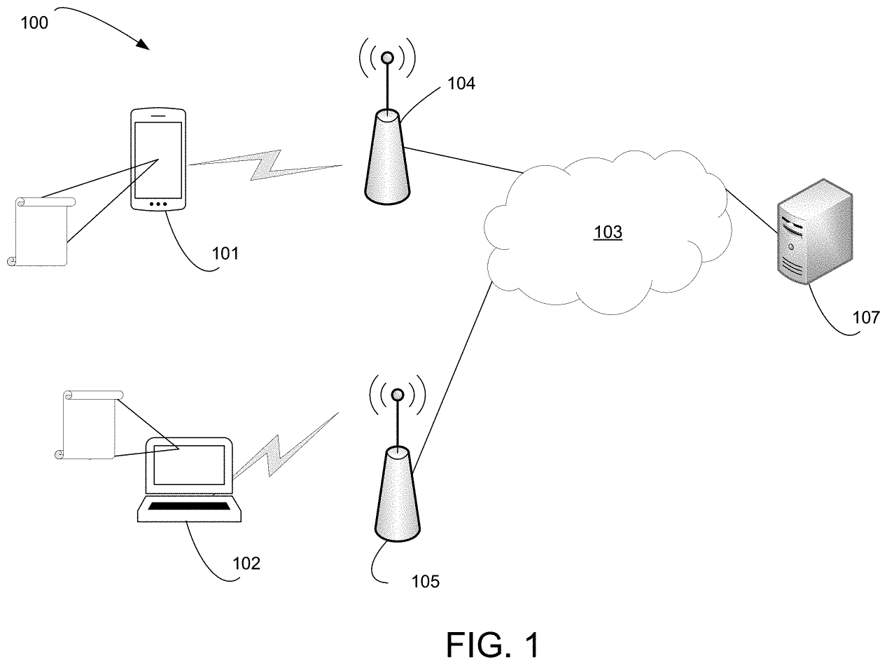

FIG. 1 illustrates an exemplary system for similarity-based search for fraud prevention. System 100 may include network 103. Device 101, device 102, base station 104, base station 105, or server 107 may be communicatively connected with each other via network 103. Network 103 may include vRouters, access points, DNS servers, firewalls, or the like virtual or physical entities. Device 101, device 102, or server 107 may be able to communicate to network 103 through a wired or wireless connection. Credit applications may be received and transmitted via device 101 or device 102 and stored in server 107 or other servers (not shown). These stored credit applications may be used in machine learning algorithms to determine which similarity patters are suspicious.

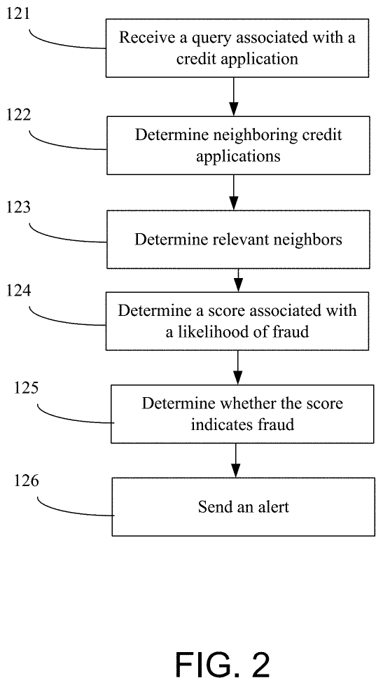

FIG. 2 illustrates an exemplary method for similarity-based search for fraud prevention. At step 121, server 107, for example, may receive a query associated with a first credit application. As disclosed herein, the credit application may include information, such as name, SSN, address, and other information.

At step 122, server 107 may determine, based on the query of step 121, neighboring credit applications (herein also referred to as neighbor) which are similar to or the same as the first credit application (e.g., a nearest neighbor search). There are multiple strategies to help determine similar applications, such as locality-sensitive hashing (LSH), which is disclosed herein. Exact match searches can be done using a standard, fast lookup in O(1) time. In contrast, searches based on textual similarity are traditionally a slow overnight batch operation, requiring the new application to be compared against all historical applications one-by-one. A way to address the real-time similarity-based search problem is Locality-Sensitive Hashing (LSH). Unlike in normal hashing, where small changes to the data result in a completely different hash value, locality-sensitive hash functions tend to map similar objects to the same hash value.

At step 123, determine relevant neighbors. The relevant neighbors may be determined based on machine learning or other techniques that may score the neighbor application. The relevant neighbors may be indicated as relevant based on reaching a first threshold. A similarity vector may be computed for each neighbor. This encodes string similarities and binary exact-match flags. For each neighbor identified in step 122, a feature vector is computed. The feature vector may encode string similarities between the query and neighbor's identity fields, boolean flags that indicate whether or not certain strings have an exact match, and a time similarity value that increases as the query and neighbor timestamp get closer together. There may also be a weighted sum that attempts to score the overall similarity (“sum score”) between the query and the neighbor based on the similarity values. Higher weights are given to uniquely identifying traits (SSN, email) relative to the weights given to non-unique traits (e.g. name, DOB, ZIP code).

Again, neighbors may be ranked by overall similarity, which may be a weighted sum of the other similarity features values in the vector. The ranking operation depends on a weighted sum, so the weights could be learned automatically. A grid search may be used to optimize the weights.

At step 124, determining, based on the relevant neighbors and the first credit application, a score associated with a likelihood of fraud. The neighbors are sorted by sum score and the top N neighbors are chosen. The feature vector is then sent to the model for scoring.

With continued reference to step 123-124, the neighbors are sorted by sum score and the top N (N=10) neighbors are chosen. Each neighbor vector is summarized to a single number by a neural network with connected layers with leaky rectified linear unit activations, and a connected sigmoid output layer (8-6-1). The scalar neighbor scores may be aggregated by the “3 Pi” aka “3-Π” function. Other uninorms are possible. The 3-Pi function is an example of a uninorm with neutral element 0.5. The final response is a sigmoid of the 3-Pi function, with two parameters. The 3-Pi uninorm is:

$${y}_{i} = {U}_{3 - Π} ( \{ {y}_{i , j} \} ) = \frac{{Π}_{j} {y}_{i , j}}{{Π}_{j} {y}_{i , j} + {Π}_{j} ( 1 - {y}_{i , j} )} \qquad ( 1 )$$

$$ℙ ( {r}_{i} = 1 ) = {( 1 + exp \vert ( - {γ}_{1} ( {y}_{i} - {γ}_{2} ) ) )}^{- 1} \qquad ( 2 )$$

For each neighbor, a feature vector may be computed. The feature vector encodes string similarities between the query and identity fields of the neighbor, Boolean flags that indicate whether or not certain strings have an exact match, or a time similarity value that increases as the query and neighbor timestamp get closer together. There may also be a weighted sum that attempts to score the overall similarity (“sum score”) between the query and the neighbor based on the similarity values. Higher/different weights may be given to uniquely identifying traits (SSN, email) relative to the weights given to non-unique traits (e.g. name, DOB, ZIP code).

At step 125, determining whether the score is associated with the likelihood of fraud reaches a second threshold (e.g., a threshold indicative of fraud). At step 126, based on the determination of step 125, sending an alert. For example, if the score of step 125 reaches the second threshold, then an alert may be sent to device 101 that fraud is suspected and addition information and/or steps may be needed for approval. In another example, if the score of step 125 does not reach the second threshold, then the first credit application may be indicated as not fraudulent or approved to device 101.

Min-Hash Locality-Sensitive Hashing (Min-Hash LSH) is a technique for searching through a database for records that are similar to a query. Min-Hash LSH is used to find neighboring credit applications as described herein (e.g., step 122). The term “LSH” by itself is a hashing technique that tends to map similar documents to the same bitmap. This is in contrast to normal hashing functions, which will produce very different hash values for documents that are very similar as long as they are not exactly identical. This property of LSH is useful for finding similar documents, because when there is a need to search through a large database for documents that are similar to a query, the bitmaps can be indexed, so there is only a search through the very small number of documents that share the same bitmap with the query.

A locality-sensitive hashing function is a function that divides a high dimensional space into separate regions. Points that are close to each other will tend to fall into the same region, but it is not guaranteed because points that are very close to each other may nevertheless be separated by a boundary between two or more regions. The boundary problem can be overcome by using several different randomized LSH functions.

Each function may divide up space in a different way. Thus, statistically, two records that are close to each other tend to fall into the same region for a high percentage of the hash functions.

The bitmap of an LSH value, for example “1001000001000001 . . . ”, may be long and is potentially sparse. The term “min-hash” refers to performing a specific permutation of the bits and making note of the first (“minimal”) index that has a “1” value. This index serves as a compact signature of the hash value in Min-Hash LSH. Many different random permutations functions (for example use P=128 permutations) are needed to give a more accurate signature of a document. It can be shown that the Jaccard similarity between a query and another document is equal to the average Jaccard similarity between their signature vectors. The error in the average Jaccard similarity scales as 1/P . With P=128, the uncertainty in the Jaccard similarity is 8.5%.

In our application, the “documents” are short strings of single identity traits (like first name, last name, email). LSH works by estimating the Jaccard similarity between documents. Documents are treated as sets of elements, and the Jaccard similarity between two sets is the intersection divided by the union (J(A, B)=A∩B/A∪B). Therefore, we need a way to break down each string into a set of elements. In general, this procedure is called shingling. The simplest way to shingle a string is to treat each individual character as a single element, but this discards too much information about what is contained in the string. A method more suitable for these short strings to run a sliding window over the string and treat n-grams (e.g. ordered groupings of 3 characters) as the elements of the sets.

Machine learning may be used to determine neighbors or flag possibly fraudulent credit applications. A machine learning option may be to send the features of all the neighbors to a logistic regression model or neural network model. A preferred model should be able to completely ignore irrelevant neighbors (e.g., neighbors that have nothing to do with the identity in the query), while collecting useful statistics about the neighbors and patterns within the neighbors that are relevant. Logistic regression may be too shallow to achieve this, and complexifying the model with a neural network may serve to drive the number of parameters even higher. However, it may be possible to use these types of models given a large enough training set. The information that may be used in the model training from the credit application may include: first name, last name, primary address, secondary address, city, state, zip code, phone number, social security number, date of birth, created date and time, and electronic mail address, among other things.

Long short-term memory (LSTM) neural networks are another option. These have been used for aggregation of non-sequential data in the GraphSAGE algorithm. Empirically, LSTMs produced a low performance model in prediction tasks of experiments.

Another option is to do some feature reduction by aggregating the neighbors with standard statistical aggregation functions like Max and Mean, and then send the reduced feature set to a deep learner such as boosted decision trees or neural nets. In experiments, this strategy performed better than LSTM, but was still not preferred to make a model with a sufficiently high true positive to false positive ratio.

The optimal model that was studied was learned aggregation. This model may apply the same neural network to each neighbor individually, and then aggregate them with a special aggregation function. The full stack consisting of the neural network and aggregation function may be learned at the same time, such that the neural network learns the optimal way to feed values to the Uninorm aggregator. During experiments, this was found to be the preferred model for this problem and had the highest true positive to false positive ratio.

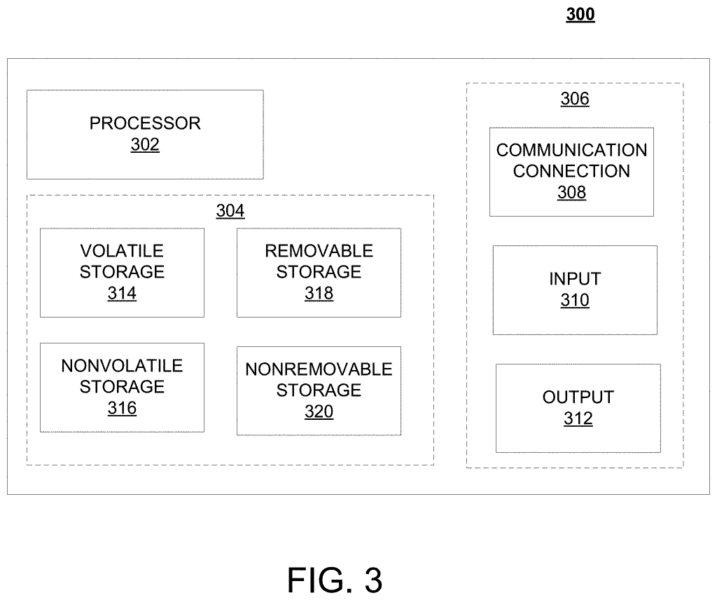

FIG. 3 is a block diagram of network device 300 that may be connected to or comprise a component of system 100. Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 3) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/5G) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

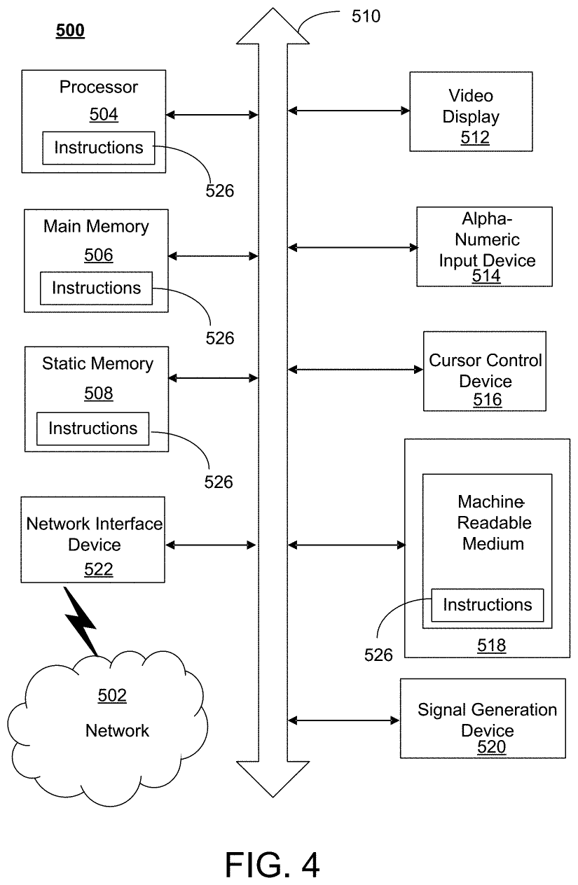

FIG. 4 depicts an exemplary diagrammatic representation of a machine in the form of a computer system 500 within which a set of instructions, when executed, may cause the machine to perform any one or more of the methods described above. One or more instances of the machine can operate, for example, as processor 302, device 101, device 102, base station 104, base station 105, server 107, and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which fraud prevention alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—similarity-based search for fraud prevention—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for similarity-based search for fraud prevention. A method, system, computer readable storage medium, or apparatus provides for receiving a query associated with a query credit application; determining, based on the query credit application, previously submitted neighboring applications; computing a respective feature vector for each neighbor application of the neighboring applications; assigning a respective score to each neighbor application based on the feature vector for each neighbor application; and based on at least a first score of an assigned respective score reaching a threshold for fraud, sending an alert. A method, system, computer readable storage medium, or apparatus provides for receiving a query associated with a credit application; in response to the query, determining neighbor applications associated with the credit application; ranking the neighbor applications; determining that a first neighbor application of the neighbor applications is ranked within a first threshold; and assigning a similarity score for the first neighbor application and the credit application. Similarities between the query and neighbor's identity fields are computed for each neighbor identified by LSH. The ranking is based on weighted sum scores which is a measure for overall similarity. The feature vectors of the top N neighbors are used in model scoring. The credit application may include application information comprising social security information, electronic mail information, date of birth information, zip code information, or address information of an applicant associated with the credit application, wherein respective application information is weighted differently for a calculation of the similarity score. All combinations in this paragraph (including the removal or addition of steps) are contemplated in a manner that is consistent with the other portions of the detailed description.

What is claimed:

1. A method comprising:
receiving a query associated with a credit application;
in response to the query, determining neighbor applications associated with the credit application;
ranking the neighbor applications;
determining that a first neighbor application of the neighbor applications is ranked within a first threshold; and
assigning a similarity score for the first neighbor application and the credit application.

2. The method of claim 1, further comprising:
determining that the similarity score is within a threshold indicative of fraud; and
based on the similarity score being within the threshold indicative of fraud, sending an alert to deny the credit application.

3. The method of claim 1, further comprising based on the similarity score, sending an alert indicative of approving or denying the credit application.

4. The method of claim 1, wherein the credit application comprises social security information, electronic mail information, date of birth information, zip code information, or address information of an applicant associated with the credit application.

5. The method of claim 1, wherein the credit application comprises application information comprising social security information, electronic mail information, date of birth information, zip code information, or address information of an applicant associated with the credit application, wherein respective application information is weighted differently for a calculation of the similarity score.

6. The method of claim 1, wherein the determining of the neighbor applications is based on an exact match search and a hashing function.

7. The method of claim 1, further comprising:
determining that the similarity score is within a threshold indicative of fraud, wherein the threshold indicative of fraud is determined by a machine learning algorithm; and
based on the similarity score being within the threshold indicative of fraud, sending an alert to deny the credit application.

8. An apparatus comprising:
a processor; and
a memory coupled with the processor, the memory storing executable instructions that when executed by the processor cause the processor to effectuate operations comprising:
receiving a query associated with a credit application;
in response to the query, determining neighbor applications associated with the credit application;
ranking the neighbor applications;
determining that a first neighbor application of the neighbor applications is ranked within a first threshold; and
assigning a similarity score for the first neighbor application and the credit application.

9. The apparatus of claim 8, further comprising:
determining that the similarity score is within a threshold indicative of fraud; and
based on the similarity score being within the threshold indicative of fraud, sending an alert to deny the credit application.

10. The apparatus of claim 8, further comprising based on the similarity score, sending an alert indicative of approving or denying the credit application.

11. The apparatus of claim 8, wherein the credit application comprises social security information, electronic mail information, date of birth information, zip code information, or address information of an applicant associated with the credit application.

12. The apparatus of claim 8, wherein the credit application comprises application information comprising social security information, electronic mail information, date of birth information, zip code information, or address information of an applicant associated with the credit application, wherein respective application information is weighted differently for a calculation of the similarity score.

13. The apparatus of claim 8, wherein the determining of the neighbor applications is based on an exact match search and a hashing function.

14. The apparatus of claim 8, further comprising:
determining that the similarity score is within a threshold indicative of fraud, wherein the threshold indicative of fraud is determined by a machine learning algorithm; and
based on the similarity score being within the threshold indicative of fraud, sending an alert to deny the credit application.

15. A computer readable storage medium storing computer executable instructions that when executed by a computing device cause said computing device to effectuate operations comprising:
receiving a query associated with a credit application;
in response to the query, determining neighbor applications associated with the credit application;
ranking the neighbor applications;
determining that a first neighbor application of the neighbor applications is ranked within a first threshold; and
assigning a similarity score for the first neighbor application and the credit application.

16. The computer readable storage medium of claim 15, further comprising:
determining that the similarity score is within a threshold indicative of fraud; and
based on the similarity score being within the threshold indicative of fraud, sending an alert to deny the credit application.

17. The computer readable storage medium of claim 15, further comprising based on the similarity score, sending an alert indicative of approving or denying the credit application.

18. The computer readable storage medium of claim 15, wherein the credit application comprises social security information, electronic mail information, date of birth information, zip code information, or address information of an applicant associated with the credit application.

19. The computer readable storage medium of claim 15, wherein the credit application comprises application information comprising electronic mail information of an applicant associated with the credit application.

20. The computer readable storage medium of claim 15, wherein the credit application comprises application information comprising social security information, electronic mail information, date of birth information, zip code information, or address information of an applicant associated with the credit application, wherein respective application information is weighted differently for a calculation of the similarity score.
